(19) United States
(12) Patent Application Publication
(10) Pub. No.: US 2006/0266702 A1
(43) Pub. Date: Nov. 30, 2006

(54) Vortex liquid purifier

(76) Inventor: You-Jin Chen, Wanli Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,920

(22) Filed: Dec. 30, 2005

(30) Foreign Application Priority Data
May 26, 2005 (TW) 094208619

(51) Int. Cl. B01D 21/26

(52) U.S. Cl. 210/512.1; 210/257.1; 210/94; 210/521

(57) ABSTRACT

A vortex liquid purifier is disclosed herein. The vortex liquid purifier employs a liquid pouring device to increase the flow rate of liquid that is to be purified, wherein the liquid pouring device has at least one inlet for liquid pouring in and a plurality of outlets for liquid flowing out. The vortex liquid purifier also utilizes a plurality of aeration pipes to make the liquid be able to flow into the storing device of the vortex liquid purifier and make liquid generate a centrifugal whirlpool. Wherein, each aeration pipe has a hole to inhale air, so that the liquid would have more bubbles after passing through the aeration pipes. By doing so, the impurities can be skimmed from the liquid by attaching to the bubbles in the centrifugal whirlpool.

### BACKGROUND OF THE INVENTION

1. Field of the Invention

This invention generally relates to a liquid purifier, and more particularly, to a vortex liquid purifier.

2. Description of the Prior Art

A conventional water purifier generally pumps water that is to be purified, making the water flow through one or several purifying material(s), and then drains the purified water for the use of specific purposes. However, one of the drawbacks of this manner is that it is necessary to clean or renew the one or several purifying material(s) after it/they has/have been used for a period of time. Moreover, the flow rate of the water purified by this manner can not meet the needs to those users requiring great quantities of purified water in a specific time. For example, the museums of marine biology and aquarium, aquacultures, and so forth.

Another manner is familiar to those ordinary skilled in the art to purify water by pumping air into the water to increase the oxygen quantity of the water. The water is then purified after the impurities, such as protein, grease, etc., in the water are oxidized and become sediments. However, this manner does not filter out the impurities and sediments, and hence the impurities and sediments still remain in the water. Also, this manner needs power to driver an air pump to pump air into the water.

Besides, a conventional water purifier generally has a fixed size, that is, the capacity of the conventional water purifier is unable to be adjusted to meet practical needs. Therefore, the use of the conventional water purifier is usually limited by the factors mentioned above.

In view of the shortcomings mentioned with the prior art of purifiers, there is a continued need to develop a new and improved purifier that overcomes the shortages associated with the prior art of purifiers. The advantages of the present invention are that it solves the problems mentioned above.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention provides a vortex liquid purifier. The vortex liquid purifier includes a storing device, a liquid pouring device, and a plurality of pipes. The liquid pouring device has at least one inlet and a plurality of outlets. Each of the pipes has a first end and a second end, the first ends of the pipes correspondingly connect with the outlets of the liquid pouring device, and the second ends of the pipes insert into the storing device and form an arrangement of tangent directions to a circle having the plumb line of the storing device as its center. By doing so, the liquid flowing into the storing device can generate a centrifugal whirlpool to mix more air to increase the oxygen quantity of the liquid.

The present invention also provides a liquid pouring device used in a vortex liquid purifier to receive liquid and make the liquid uniformly flow out the liquid pouring device. The liquid pouring device includes a hollow ring with a plurality of outlets on its downside and at least one inlet.

The present invention still provides a vortex liquid purifier. The vortex liquid purifier includes a liquid pouring device, a plurality of ring modules, and a ring container. The liquid pouring device has at least one inlet and a plurality of outlets. Each of the ring modules has a plurality of first pipes surrounding with. The ring container has a plurality of second pipes inserting into and the ends of the second pipes form an arrangement of tangent directions to a circle having the plumb line of the ring container as its center. Wherein, the ring modules are stacked up on the ring container to form a storing device and the liquid pouring device is on the storing device. Also, the outlets of the liquid pouring device correspondingly connect with the first pipes of the top ring module, the first pipes of each ring module are correspondingly connected, and the second pipes of the ring container correspondingly connect with the first pipes of the bottom ring module.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A illustrates a preferred embodiment in accordance with the present invention;

FIG. 1B illustrates the embodiment shown in FIG. 1 from another direction with a part of cutaway view;

FIG. 2 illustrates a cutaway view of a preferred embodiment in accordance with the present invention;

FIG. 3 illustrates a preferred pipe embodiment in accordance with the present invention;

FIG. 4 depicts a cross-sectional view of a preferred embodiment in accordance with the present invention; and

FIG. 5 illustrates another preferred embodiment in accordance with the present invention.

### DETAILED DESCRIPTION OF THE PREFERRED EMBODIMENTS

Some embodiments of the present invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

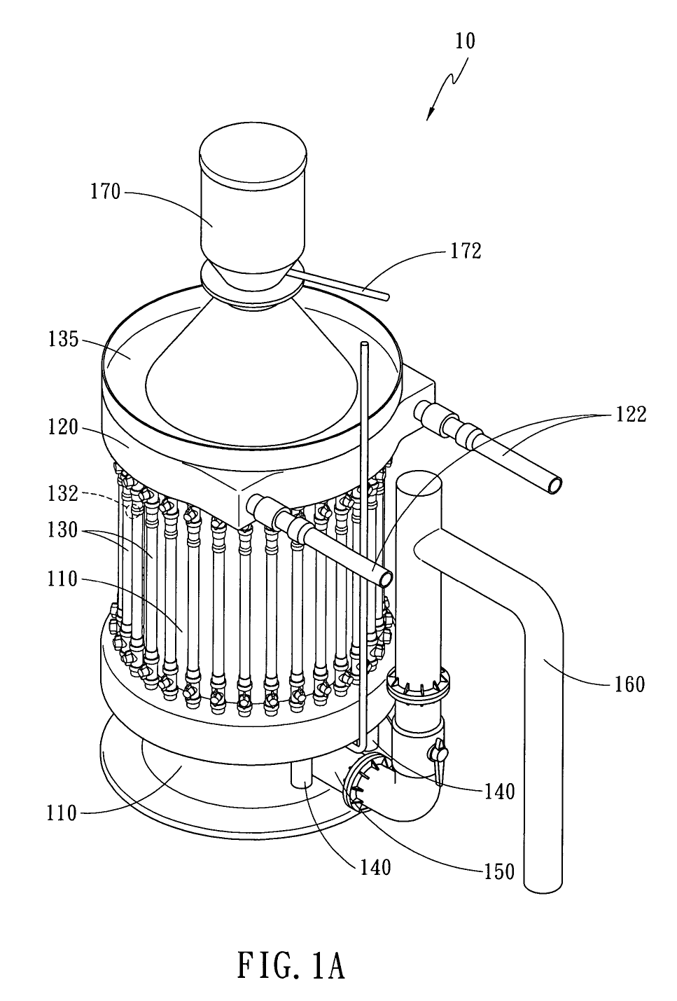

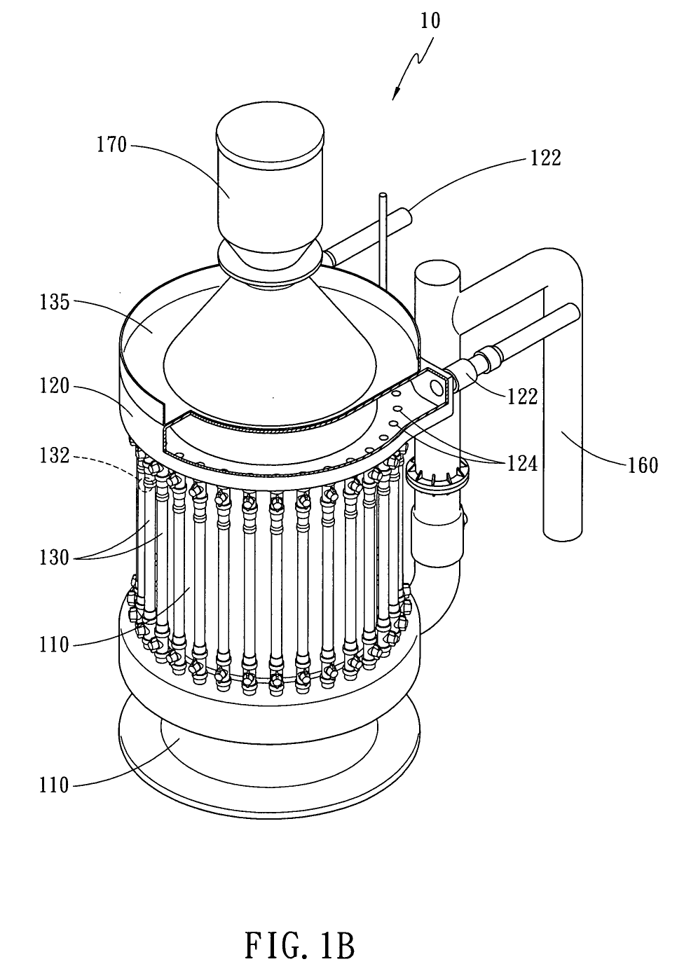

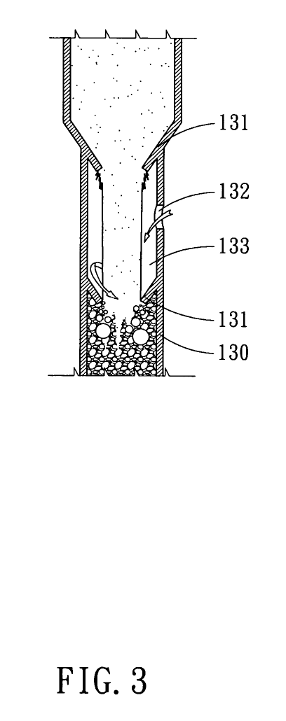

Referring to FIGS. 1A and 1B, one preferred embodiment 10 in reference to the present invention is illustrated in different directions. A storing device 110 is used to store and process liquid that is to be purified. A liquid pouring device 120 connects the top of the storing device 110 by surrounding with. Herein, the liquid pouring device 120 has at least one inlet 122 and a plurality of outlets 124. In this embodiment, the liquid pouring device 120 has two inlets 122, but should not be limited. The inlets 122 are used to receive the liquid, and the outlets 124 make the liquid uniformly flow out the liquid pouring device 120. In other words, the multiple-in and multiple-out structure is able to increase the flow rate of the liquid. A plurality of pipes 130 surround the storing device 110 equidistantly. Each pipe 130 has a first end and a second end. The first ends of the pipes 130 correspondingly connect with the outlets 124 of the liquid pouring device 120. The second ends of the pipes 130 insert into the storing device 110 and form an arrangement of tangent directions to a circle having the plumb line of the storing device 110 as its center. By doing so, the liquid flowing into the storing device 110 can generate a centrifugal whirlpool to mix more air to increase the oxygen quantity of the liquid. Further, each pipe 130 could have at least one first hole 132 used to mix more air into the liquid, that is, the air is inhaled by the first hole 132 and mixed into the liquid when the liquid flows through the pipe 130 (details will be described in FIG. 3).

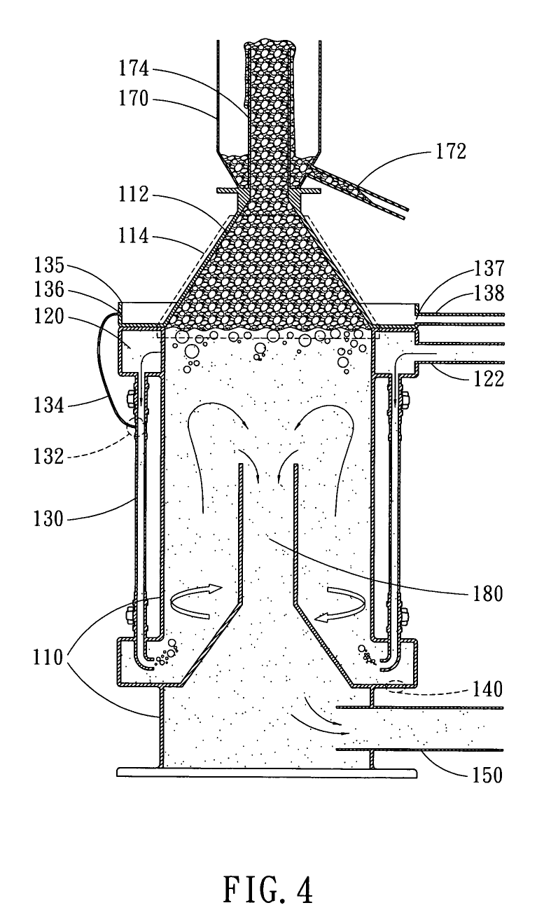

An overflowing device 135 is used to collect the overflowing liquid from the first holes 132 of the pipes 130 (details will be described in FIG. 4). Further, the storing device 110 could have one or more than one liquid pouring inlet(s) 140 to increase the flow rate of the liquid flowing into the storing device 110. A bubble collecting device 170 is on the storing device 110 to collect the bubbles generated in the liquid purifying process, and drains the bubbles through a bubble draining pipe 172 connected at the bottom of the bubble collecting device 170. A purified liquid pipe 160 connects with a purified liquid outlet 150 to drain the purified liquid out the storing device 110.

It should be understood that the quantity of the inlet 122 of the liquid pouring device 120 could be adjusted to meet practical needs and should not be limited to two. Similarly, the number of the liquid pouring inlet 140 could be adjusted according to the practical needs as well. Moreover, the shape of the storing device 110 should not be limited to the shape disclosed herein. Also, in the present invention, the pipes 130 could be transparent for the liquid being disinfected by light when the liquid flows through the pipes 130.

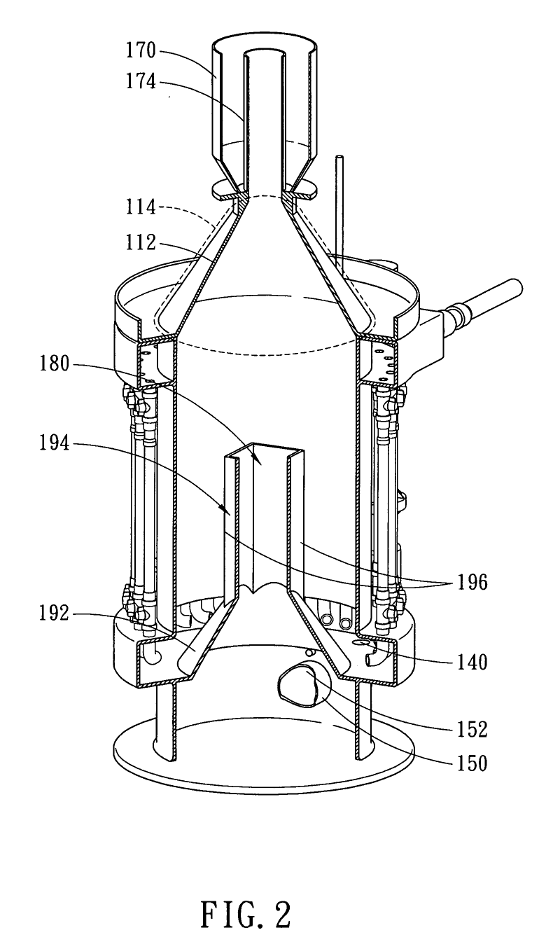

Referring to FIG. 2, a cutaway view of a preferred structure in accordance with the present invention is illustrated. The second ends of the pipes 130 (FIG. 1A) insert into the storing device 110 (FIG. 1A) and form an arrangement of tangent directions to a circle having the plumb line of the storing device 110 as its center. By doing so, the liquid flowing into the storing device 110 can generate a centrifugal whirlpool to mix more air to increase the oxygen quantity and the bubbles. The impurities, such as protein, grease, etc., in the liquid then can be decomposed and/or attach to the bubbles to float on the surface of the liquid.

An internal partition 192 could be a cone shape to make the flow of the centrifugal whirlpool rise along its incline, so that the impurities in the liquid have more chances to be decomposed and attach to the bubbles by well stirring the liquid. Wherein, the internal partition 192 has an open on its top. A polygonal pipe 194 connects with the open of the internal partition 192. The polygonal pipe 194 can slow down the flow speed of the centrifugal whirlpool by its a plurality of edges 196 and further provides a function like stirring to avoid the phenomenon that the impurities floating on the surface of the liquid are drawn into the purified liquid by the centrifugal whirlpool. The purified liquid is then drained to under the internal partition 192 via an internal outlet 180 and drained out the storing device via the purified liquid outlet 150. Herein, the purified liquid outlet 150 has a re-entrant 152 to avoid generating a whirlpool.

The storing device could further have a bubble piling device 112 on its top for temporarily storing the bubbles generated by the centrifugal whirlpool. The bubble piling device 112, for example, could be an inverted funnel shape 114 in order to speed up the rising rate of the bubbles piling. A bubble leading pipe 174 has a third end and a fourth end. The third end connects the top of the bubble piling device 112 and the fourth end inserts into the bubble collecting device 170, so that the bubbles in the bubble piling device 112 can be led to the bubble collecting device 170. In the present embodiment, the bubbles in the bubble collecting device 170 are drained away by the bubble draining pipe 172 (FIG. 1) connected at the bottom of the bubble collecting device 170.

Referring to FIG. 3, a cross-sectional view for a preferred pipe embodiment in accordance with the present invention is illustrated. A pipe 130 could have two funneled structures 131 inside in order to speed up the flow rate of the liquid. Moreover, the pipe 130 could have at least one first hole 132 between the two funneled structures 131 to inhale air 133 to mix into the liquid passing through the pipe 130. Whereby, the liquid could have more bubbles inside and its flow rate is also speeded up.

Referring to FIG. 4, a cross-sectional view of the embodiment shown in FIGS. 1A, 1B and 2 is illustrated. The liquid that is to be purified flows into the liquid pouring device 120 via the inlet 122. The liquid are then uniformly distributed to the pipes 130 correspondingly connecting with the outlets 124 (FIG. 1B) of the liquid pouring device 120. Since a plurality of overflowing pipes 134 connect the first holes 132 of the pipes 130 and a plurality of second holes 136 of the overflowing device 135, the air is then inhaled into the pipes 130 through the second holes 136, the overflowing pipes 134, and the first holes 132 when the liquid flows in the pipes 130. By doing so, the liquid could have more oxygen quantity and/or bubbles inside.

The second ends of the pipes 130 are inserted into the storing device 110 and form an arrangement of tangent directions to a circle having the plumb line of the storing device 110 as its center. Therefore, the liquid flowing into the storing device 110 via the pipes 130 is able to generate a centrifugal whirlpool. The impurities, such as protein, grease, etc., in the liquid can be decomposed and/or attach to the bubbles in the centrifugal whirlpool. Also, the impurities attaching to the bubbles will gradually float on the surface of the liquid due to the bubbles rising and piling. This makes the impurities be separated from the liquid and also make the liquid purified. Then, the purified liquid is drained out the storing device 110 through the internal outlet 180 and the purified liquid outlet 150.

The storing device 110 could further have the bubble piling device 112 on its top for temporarily storing the bubbles generated by the pipes 130 and the centrifugal whirlpool. The bubble piling device 112, for example, could be an inverted funnel shape 114 to speed up the rising and piling rate of the bubbles. The bubble leading pipe 174 connects the top of the bubble piling device 112 and inserts into the bubble collecting device 170, so that the bubbles are able to be led into the bubble collecting device 170. In this embodiment, the bubbles in the bubble collecting device 170 are drained away via the bubble draining pipe 172 connected at the bottom of the bubble collecting device 170.

Besides, the first holes 132, the overflowing pipes 134, and the second holes 136 provide not only the paths for inhaling air but also the function like collecting the overflowing liquid from the holes 132. That is, the liquid will overflow from the first holes 132 if the liquid purifier just starts to work and/or just stops working. The overflowing liquid is then collected in the overflowing device 135 through the first holes 132, the overflowing pipes 134, and the second holes 136, and is drained away by a third hole 137 and a draining pipe 138.

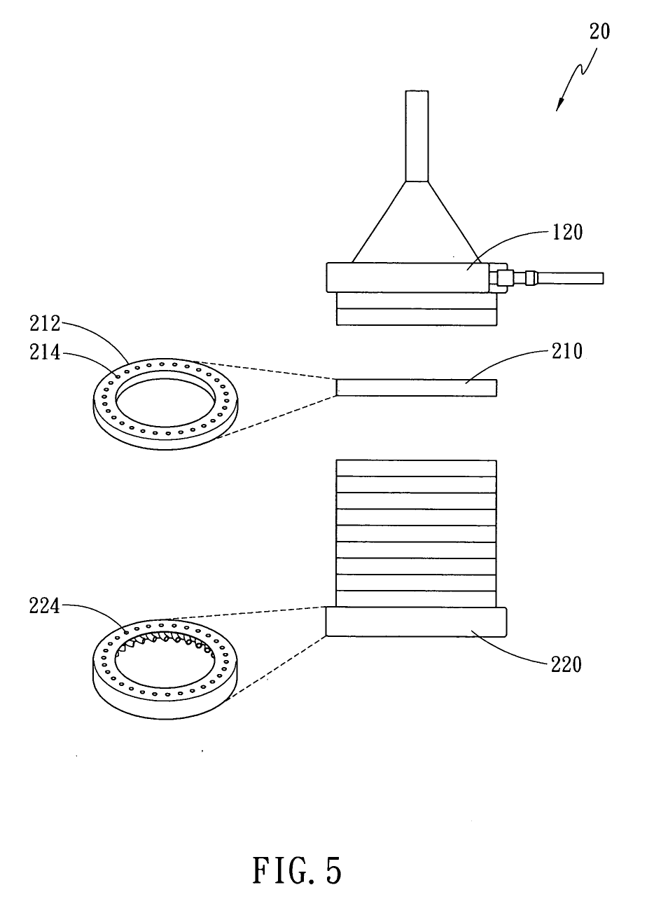

Referring to FIG. 5, another preferred embodiment in reference to the present invention is illustrated. Since some parts in the present embodiment have the same structures and functions as those shown in FIGS. 1A, 1B, 2, 3, and 4, details will not be described again. The preferred embodiment 20 includes a liquid pouring device 120, a plurality of ring modules 210, and a ring container 220. The liquid pouring device 120 has at least one inlet and a plurality of outlets. Each of the ring modules 210 could be a ring 212 and has a plurality of first pipes 214 surrounding with. The ring container 220 has a plurality of second pipes 224 inserting with and the ends of the second pipes 224 form an arrangement of tangent directions to a circle having the plumb line of the ring container 220 as its center. Wherein, the ring modules 210 are stacked up on the ring container 224 to form a storing device and the liquid pouring device 120 is on the storing device. Also, the outlets of the liquid pouring device 120 correspondingly connect with the first pipes 214 of the top ring module, the first pipes 214 of each ring module 210 are correspondingly connected, and the second pipes 224 of the ring container 220 correspondingly connect with the first pipes 214 of the bottom ring module. Whereby, the capacity of the liquid purifier 20 is able to be adjusted based on the number of stacked ring module 210 to meet practical needs. That is, the capacity of the liquid purifier 20 increases when more the ring modules 210 are stacked up. Also, the first pipe 214 could have the structure described in FIG. 3, so that the liquid flowing through the first pipe 214 can be speeded up and have more air inside.

However, it should be understood herein that more air will be inhaled into the storing device 110 and the centrifugal force of the centrifugal whirlpool will reinforce when the number of the pipes 130 increase. In other words, this increases the oxygen quantity of the liquid and generates much more bubbles to increase the efficiency for the impurities being oxidized and/or attach to.

Although specific embodiments have been illustrated and described, it will be obvious to those skilled in the art that various modifications may be made without departing from what is intended to be limited solely by the appended claims.

What is claimed is:

1. A vortex liquid purifier, comprising:
a storing device;
a liquid pouring device, having at least one inlet and a plurality of outlets, wherein said liquid pouring device connects the top of said storing device by surrounding with; and
a plurality of pipes, each of said plurality of pipes having a first end and a second end, wherein said first ends correspondingly connect with said plurality of outlets of said liquid pouring device, said second ends insert into said storing device and form an arrangement of tangent directions to the circle having the plumb line of said storing device as the center, whereby the liquid flowing into said storing device is able to generate a centrifugal whirlpool.

2. The vortex liquid purifier according to claim 1, wherein said storing device further comprises an internal partition, said internal partition is a cone shape to make the flow of said centrifugal whirlpool rise along its incline, said internal partition has an open on its top.

3. The vortex liquid purifier according to claim 2, wherein said storing device further comprises a polygonal pipe, said polygonal pipe connects with said open of said internal partition, said polygonal pipe can slow down the flow speed of said centrifugal whirlpool by its a plurality of edges and further provides a function like stirring to avoid the phenomenon that impurities floating on the surface of the liquid are drawn into the purified liquid by said centrifugal whirlpool.

4. The vortex liquid purifier according to claim 1, wherein said plurality of pipes are transparent.

5. The vortex liquid purifier according to claim 1, wherein said plurality of pipes surround said storing device equidistantly.

6. The vortex liquid purifier according to claim 1, wherein each of said plurality of pipes has one first hole to inhale air.

7. The vortex liquid purifier according to claim 6, wherein said each of said plurality of pipes further has two funneled structures inside to speed up the flow rate of the liquid, said one first hole is between said two funneled structures.

8. The vortex liquid purifier according to claim 6, further comprising:
an overflowing device, locating on said liquid pouring device to collect the overflowing liquid from said first holes of said plurality of pipes, said overflowing device having a plurality of second holes and at least one third hole;
a plurality of overflowing pipes, correspondingly connecting said first holes of said plurality of pipes and said plurality of second holes of said overflowing device, so as to lead the overflowing liquid from said first holes of said plurality of pipes to said overflowing device; and
at least one draining pipe, connecting with said at least one third hole to drain away the overflowing liquid in said overflowing device.

9. The vortex liquid purifier according to claim 1, wherein said storing device further comprises at least one liquid pouring inlet.

10. The vortex liquid purifier according to claim 1, wherein said storing device further comprises a purified liquid outlet, said purified liquid outlet has a re-entrant to avoid generating a whirlpool.

11. The vortex liquid purifier according to claim 1, wherein said liquid pouring device is a hollow ring with said at least one inlet and said plurality of outlets on its downside.

12. A vortex liquid purifier, comprising:
a liquid pouring device, having at least one inlet and a plurality of outlets;
a plurality of ring modules, each of said plurality of ring modules having a plurality of first pipes surrounding with; and
a ring container, having a plurality of second pipes inserting into, wherein the ends of said plurality of second pipes form an arrangement of tangent directions to a circle having the plumb line of said ring container as the center;
wherein, said plurality of ring modules are stacked up on said ring container to form a storing device, said liquid pouring device is on said storing device, said plurality of outlets of said liquid pouring device correspondingly connect with said plurality of first pipes of the top ring module, said plurality of first pipes of each ring module correspondingly connect with, and said plurality of second pipes of said ring container correspondingly connect with said plurality of first pipes of the bottom ring module.

13. The vortex liquid purifier according to claim 12, wherein said plurality of first pipes are transparent.

14. The vortex liquid purifier according to claim 12, wherein each of said plurality of first pipes of one of said plurality of ring module has one first hole to inhale air.

15. The vortex liquid purifier according to claim 14, wherein said each of said plurality of first pipes further has two funneled structures inside to speed up the flow rate of the liquid, said one first hole is between said two funneled structures.
